(19) United States
(12) Patent Application Publication
(10) Pub. No.: US 2026/0321481 A1
(43) Pub. Date: Oct. 15, 2026

(54) THREE-PHASE MAGNETIC INTEGRATED ASSEMBLY

(71) Applicant: Delta Electronics (Shanghai) Co., Ltd., Shanghai (CN)

(72) Inventors: Tongmin LIU, Shanghai (CN); Shiwei LIU, Shanghai (CN)

(21) Appl. No.: 19/642,590

(22) Filed: Apr. 8, 2026

(30) Foreign Application Priority Data
Apr. 11, 2025 (CN) 202510460696.4

(51) Int. Cl. H01F 27/28; H01F 27/24

(52) U.S. Cl. CPC H01F 27/28; H01F 27/24

(57) ABSTRACT

The application provides a three-phase magnetic integrated assembly, including a first phase magnetic device having a first loss, a second phase magnetic device having a second loss and a third phase magnetic device having a third loss, the second loss is less than 90% of the first loss and 90% of the third loss by adjusting one or more parameters of the second phase magnetic device, and the one or more parameters include a thickness of the air gap of a magnetic core, turns of windings, a cross-sectional area of the magnetic core or a length of magnetic core.

### CROSS-REFERENCE TO RELATED APPLICATIONS

This non-provisional application claims priority under 35 U.S.C. § 119 (a) on Patent application Ser. No. 202510460696.4 filed in P.R. China on Apr. 11, 2025, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### BACKGROUND OF THE INVENTION

### 1. Field of the Invention

The application relates to a magnetic device, and in particular, to a three-phase magnetic integrated assembly.

### 2. Related Art

As for high power density and large power switching power supplies, it is necessary to use magnetic integration technique to reduce a volume of the magnetic devices, so as to enhance working efficiency. In application scenarios of multiphase parallel connection, powers of the respective phases are often the same, and losses of the respective phase magnetic devices are also almost the same. After using magnetic integration, the magnetic devices at different phases and having same loss are integrated together, but heat dissipation conditions of the magnetic devices at different positions are largely different, causing a low temperature of the magnetic devices at the position where heat dissipation situations are good, and a high temperature of the magnetic devices at the position where heat dissipation situations are bad, even an unstable situation.

As for the three-phase magnetic integrated assembly (transformer or inductor), the common design method is that the respective phase magnetic devices use the same parameters, and the phases are staggered by 120°, so that a magnetic flux and loss of a magnetic core of each phase magnetic device are the same, but when the three phase magnetic devices work together, the magnetic device at middle phase will be heated by the heat source generated by other two phase magnetic devices, and heat dissipation condition of the magnetic device at middle phase is worse than that of other two phase magnetic devices, causing that it is difficult for the temperature of the magnetic device at middle phase to be stable.

Therefore, as for application scenarios of multiphase parallel connection converters, in particular, scenarios of three or more than phases parallel connection, after the magnetic devices use magnetic integration, it is necessary to address the problem of how to stabilize temperatures of the magnetic core and the windings at different positions of the magnetic devices in a safe temperature range.

### SUMMARY OF THE INVENTION

An object of the application is to provide a three-phase magnetic integrated assembly capable of solving one or more deficiencies in the prior art.

In order to achieve the above object, the application provides a three-phase magnetic integrated assembly, including a first phase magnetic device having a first loss, a second phase magnetic device having a second loss and a third phase magnetic device having a third loss, wherein the second loss is less than 90% of the first loss and 90% of the third loss by adjusting one or more parameters of the second phase magnetic device, and the one or more parameters include a thickness of the air gap of a magnetic core, turns of windings, a cross-sectional area of the magnetic core or a length of magnetic core.

### BRIEF DESCRIPTION OF THE DRAWINGS

To more clearly explain the technical solution carried out in the application, hereinafter the accompanying drawings to be used in the embodiments are simply introduced.

FIG. 1 is a structural diagram of a three-phase magnetic integrated assembly in a first preferable embodiment;

FIG. 2 is a structural diagram of a three-phase magnetic integrated assembly in a second preferable embodiment;

FIG. 3 is a structural diagram of a three-phase magnetic integrated assembly in a third preferable embodiment;

FIG. 4 is a structural diagram of a three-phase magnetic integrated assembly in a fourth preferable embodiment;

FIG. 5 is a schematic diagram where the three-phase magnetic integrated assembly is an integration of three phase inductors;

FIG. 6 is a schematic diagram where the three-phase magnetic integrated assembly is an integration of three phase transformers;

FIG. 7 is a schematic diagram where the three-phase magnetic integrated assembly is an integration of three phase transformers and inductors;

FIG. 8 is a schematic diagram where the three-phase magnetic integrated assembly is an integration of three phase transformers and leakage inductors;

FIG. 9 is a circuit topology of the three-phase magnetic integrated assembly;

FIG. 10 is a structural diagram of the symmetrically designed three-phase magnetic integrated assembly;

FIG. 11 is a distribution diagram of tested temperatures of the symmetrically designed three-phase magnetic integrated assembly;

FIG. 12 is a distribution diagram of tested temperatures of the asymmetrically designed three-phase magnetic integrated assembly in the application.

### DETAILED EMBODIMENTS OF THE INVENTION

The exemplary embodiments will now be described more fully with reference to the accompanying drawings. The exemplary embodiments can, however, be implemented in various forms, and should not be construed as being limited to the embodiments set forth herein; rather, these embodiments are provided so that the application will be thorough and complete, and will fully convey the concept of the exemplary embodiments to those skilled in the art.

When introducing elements or constituting parts or the like described and/or illustrated here, the terms “one”, “a (an)”, “the”, “said” and “at least one” represent one or more elements or constituting parts or the like. The terms “include”, “comprise” and “have” represent an open and inclusive meaning, and also refer to additional elements or constituting parts or the like in addition to the listed elements or constituting parts or the like. Moreover, the terms “first”, “second” and the like in the claims are only used as reference signs, rather limiting the number of objects. In the drawings, the same reference signs denote the same or similar component. On the other hand, the commonly known components and steps are not described in the embodiments to avoid causing unnecessary limit to the present disclosure. Moreover, in order to simplify the accompanying drawings, some known customary structures and elements are drawn in the accompanying drawings in a simple illustrative manner.

The application provides a three-phase magnetic integrated assembly, including a first phase magnetic device having a first loss, a second phase magnetic device having a second loss and a third phase magnetic device having a third loss, wherein the second loss is less than 90% of the first loss and 90% of the third loss by adjusting one or more parameters of the second phase magnetic device, and the one or more parameters include a thickness of the air gap of a magnetic core, turns of windings, a cross-sectional area of the magnetic core or a length of magnetic core. The second phase magnetic device can refer to any phase magnetic device in the three-phase magnetic integrated assembly, and preferably, the second phase magnetic device is located between the first phase magnetic device and the third phase magnetic device.

Through asymmetrical design of the three-phase magnetic integrated assembly, loss of one phase magnetic device is less than losses of other phase magnetic devices, thereby improving heat dissipation capability of the three-phase magnetic integrated assembly.

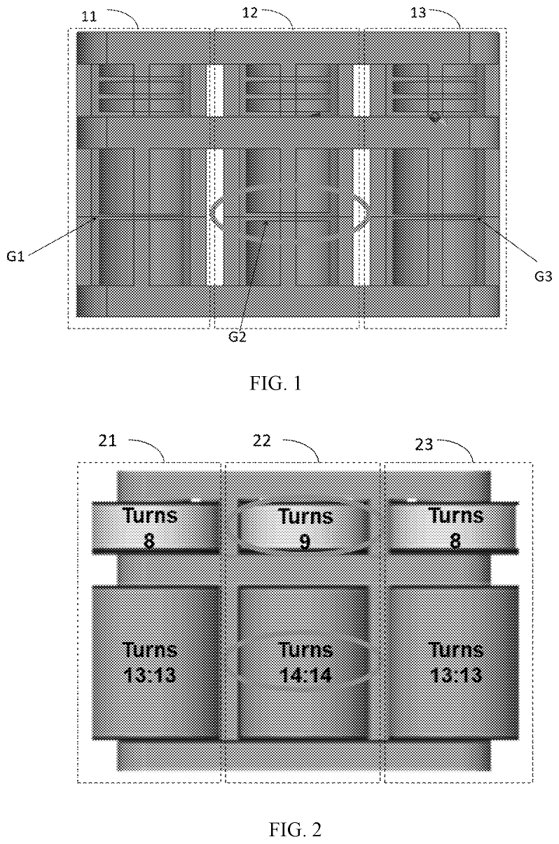

FIG. 1 is a structural diagram of a three-phase magnetic integrated assembly in a first preferable embodiment. As shown in FIG. 1, the three-phase magnetic integrated assembly includes a first phase magnetic device 11, a second phase magnetic device 12 and a third phase magnetic device 13, the second phase magnetic device 12 is located between the first phase magnetic device 11 and the third phase magnetic device 13, and the first phase magnetic device 11, the second phase magnetic device 12 and the third phase magnetic device 13 include magnetic cores and windings winded onto the magnetic cores, respectively. The magnetic core of the first phase magnetic device 11 has a first air gap G1, the magnetic core of the second phase magnetic device 12 has a second air gap G2, and the magnetic core of the third phase magnetic device 13 has a third air gap G3. Through asymmetrical design, a thickness of the air gap of the magnetic core of the second phase magnetic device 12 and a thickness of the air gap of the magnetic core of the first phase magnetic device 11 differ by 10% or more, and the thickness of the air gap of the magnetic core of the second phase magnetic device 12 and a thickness of the air gap of the magnetic core of the third phase magnetic device 13 differ by 10% or more. Preferably, in this embodiment, the thickness of the air gap of the magnetic core of the second phase magnetic device 12 is larger than the thickness of the air gap of the magnetic core of the first phase magnetic device 11, and the thickness of the air gap of the magnetic core of the second phase magnetic device 12 is larger than the thickness of the air gap of the magnetic core of the third phase magnetic device 13, so that the object that loss of the second phase magnetic device 12 is less than losses of other phase magnetic devices can be achieved. In other embodiments, the thickness of the air gap of the magnetic core of the second phase magnetic device 12 and the thickness of the air gap of the magnetic core of the first phase magnetic device 11 may have other numerical size relations, and the thickness of the air gap of the magnetic core of the second phase magnetic device 12 and the thickness of the air gap of the magnetic core of the third phase magnetic device 13 may also have other numerical size relations. For example, the thickness of the air gap of the magnetic core of the second phase magnetic device 12 is less than the thickness of the air gap of the magnetic core of the first phase magnetic device 11, and the thickness of the air gap of the magnetic core of the second phase magnetic device 12 is less than the thickness of the air gap of the magnetic core of the third phase magnetic device 13, but the application is not limited thereto. It shall be noted that a difference between the thickness of the air gap of the magnetic core of the second phase magnetic device 12 and the thickness of the air gap of the magnetic core of the first phase magnetic device 11, and a difference between the thickness of the air gap of the magnetic core of the second phase magnetic device 12 and the thickness of the air gap of the magnetic core of the third phase magnetic device 13 are produced by asymmetrical design, rather caused due to production or assembly tolerance.

FIG. 2 is a structural diagram of a three-phase magnetic integrated assembly in a second preferable embodiment. As shown in FIG. 2, the three-phase magnetic integrated assembly includes a first phase magnetic device 21, a second phase magnetic device 22 and a third phase magnetic device 23, the second phase magnetic device 22 is located between the first phase magnetic device 21 and the third phase magnetic device 23, and the first phase magnetic device 21, the second phase magnetic device 22 and the third phase magnetic device 23 include magnetic cores and windings winded onto the magnetic cores, respectively. Through asymmetrical design, the turns of windings of the second phase magnetic device 22 and the turns of windings of the first phase magnetic device 21 are different, and the turns of windings of the second phase magnetic device 22 and the turns of windings of the third phase magnetic device 23 are different. Preferably, in this embodiment, the turns of windings of the second phase magnetic device 22 is more than the turns of windings of the first phase magnetic device 21, and the turns of windings of the second phase magnetic device 22 is more than the turns of windings of the third phase magnetic device 23. For example, referring to FIG. 2, the first phase magnetic device 21, the second phase magnetic device 22 and the third phase magnetic device 23 all include an inductor winding and a transformer winding, and the transformer winding includes a primary winding and a secondary winding. The turns of the inductor windings of the first phase magnetic device 21 and the third phase magnetic device 23 is 8, the turns of the primary winding and the secondary winding of the transformer winding is 13, respectively, the turns of the inductor winding of the second phase magnetic device 22 is 9, and the turns of the primary winding and the secondary winding of the transformer winding is 14, respectively, so that the object that loss of the second phase magnetic device 22 is less than losses of other phase magnetic devices can be achieved. In other embodiments, the turns of windings of the second phase magnetic device 22 and the turns of windings of the first phase magnetic device 21 may have other numerical size relations, and the turns of windings of the second phase magnetic device 22 and the turns of windings of the third phase magnetic device 23 may also have other numerical size relations. For example, the turns of windings of the second phase magnetic device 22 is less than the turns of windings of the first phase magnetic device 21, and the turns of windings of the second phase magnetic device 22 is less than the turns of windings of the third phase magnetic device 23, but the application is not limited thereto.

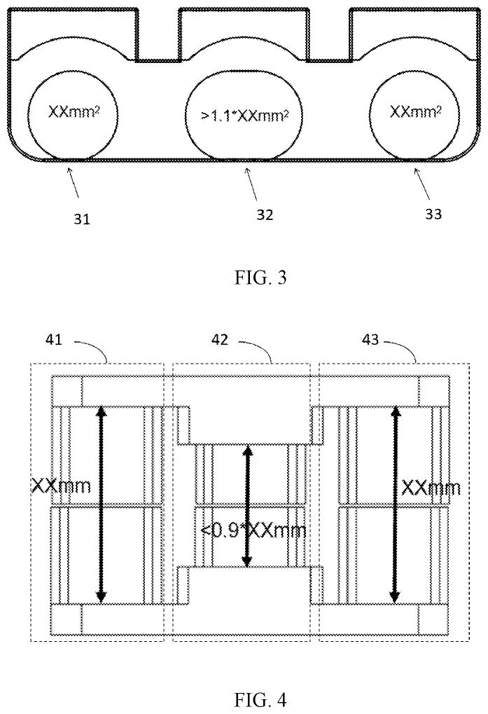

FIG. 3 is a structural diagram of a three-phase magnetic integrated assembly in a third preferable embodiment. As shown in FIG. 3, the three-phase magnetic integrated assembly includes a first phase magnetic device 31, a second phase magnetic device 32 and a third phase magnetic device 33, the second phase magnetic device 32 is located between the first phase magnetic device 31 and the third phase magnetic device 33, and the first phase magnetic device 31, the second phase magnetic device 32 and the third phase magnetic device 33 include magnetic cores and windings winded onto the magnetic cores, respectively. Through asymmetrical design, a cross-sectional area of the magnetic core of the second phase magnetic device 32 and a cross-sectional area of the magnetic core of the first phase magnetic device 31 differ by 10% or more, and the cross-sectional area of the magnetic core of the second phase magnetic device 32 and a cross-sectional area of the magnetic core of the third phase magnetic device 33 differ by 10% or more. Preferably, in this embodiment, the cross-sectional area of the magnetic core of the second phase magnetic device 32 is larger than the cross-sectional area of the magnetic core of the first phase magnetic device 31, and the cross-sectional area of the magnetic core of the second phase magnetic device 32 is larger than the cross-sectional area of the magnetic core of the third phase magnetic device 33. For example, referring to FIG. 3, the cross-sectional area of the magnetic core of the first phase magnetic device 31 and the cross-sectional area of the magnetic core of the third phase magnetic device 33 are XXmm², where XX can select a suitable value according to actual applications, and the cross-sectional area of the magnetic core of the second phase magnetic device 32 is larger than 1.1 times XXmm², so that the object that loss of the second phase magnetic device 32 is less than losses of other phase magnetic devices can be achieved. In other embodiments, the cross-sectional area of the magnetic core of the second phase magnetic device 32 and the cross-sectional area of the magnetic core of the first phase magnetic device 31 may have other numerical size relations, and the cross-sectional area of the magnetic core of the second phase magnetic device 32 and the cross-sectional area of the magnetic core of the third phase magnetic device 33 may also have other numerical size relations. For example, the cross-sectional area of the magnetic core of the second phase magnetic device 32 is less than the cross-sectional area of the magnetic core of the first phase magnetic device 31, and the cross-sectional area of the magnetic core of the second phase magnetic device 32 is less than the cross-sectional area of the magnetic core of the third phase magnetic device 33, but the application is not limited thereto. It shall be noted that a difference between the cross-sectional area of the magnetic core of the second phase magnetic device 32 and the cross-sectional area of the magnetic core of the first phase magnetic device 31, and a difference between the cross-sectional area of the magnetic core of the second phase magnetic device 32 and the cross-sectional area of the magnetic core of the third phase magnetic device 33 are produced by asymmetrical design, rather caused by production or assembly tolerance.

FIG. 4 is a structural diagram of a three-phase magnetic integrated assembly in a fourth preferable embodiment. As shown in FIG. 4, the three-phase magnetic integrated assembly includes a first phase magnetic device 41, a second phase magnetic device 42 and a third phase magnetic device 43, the second phase magnetic device 42 is located between the first phase magnetic device 41 and the third phase magnetic device 43, and the first phase magnetic device 41, the second phase magnetic device 42 and the third phase magnetic device 43 include magnetic cores and windings winded onto the magnetic cores, respectively. Through asymmetrical design, a length of the magnetic core of the second phase magnetic device 42 and a length of the magnetic core of the first phase magnetic device 41 differ by 10% or more, and the length of the magnetic core of the second phase magnetic device 42 and a length of the magnetic core of the third phase magnetic device 43 differ by 10% or more. Preferably, in this embodiment, the length of the magnetic core of the second phase magnetic device 42 is less than the length of the magnetic core of the first phase magnetic device 41, and the length of the magnetic core of the second phase magnetic device 42 is less than the length of the magnetic core of the third phase magnetic device 43. For example, referring to FIG. 4, the length of the magnetic core of the first phase magnetic device 41 and the length of the magnetic core of the third phase magnetic device 43 are XX mm, where XX may select a suitable value according to actual applications, and the length of the magnetic core of the second phase magnetic device 42 is less than 0.9 times XX mm, so that the object that loss of the second phase magnetic device 42 is less than losses of other phase magnetic devices can be achieved. In other embodiments, the length of the magnetic core of the second phase magnetic device 42 and the length of the magnetic core of the first phase magnetic device 41 may have other numerical size relations, and the length of the magnetic core of the second phase magnetic device 42 and the length of the magnetic core of the third phase magnetic device 43 may also have other numerical size relations. For example, the length of the magnetic core of the second phase magnetic device 42 is greater than the length of the magnetic core of the first phase magnetic device 41, and the length of the magnetic core of the second phase magnetic device 42 is greater than the length of the magnetic core of the third phase magnetic device 43, but the application is not limited thereto. It shall be noted that a difference between the length of the magnetic core of the second phase magnetic device 42 and the length of the magnetic core of the first phase magnetic device 41, and a difference between the length of the magnetic core of the second phase magnetic device 42 and the length of the magnetic core of the third phase magnetic device 43 are produced by asymmetrical design, rather caused by production or assembly tolerance.

In any embodiment, loss of the second phase magnetic device can be reduced by adjusting any one or more parameters of the thickness of the air gap of the magnetic core, the turns of windings, the cross-sectional area of the magnetic core or the length of the magnetic core of the second phase magnetic device in the three-phase magnetic integrated assembly. Moreover, the adjustable parameters of the second phase magnetic device are not limited to the thickness of the air gap of the magnetic core, the turns of windings, the cross-sectional area of the magnetic core and the length of the magnetic core listed in the above embodiments, and in other embodiments, asymmetrical design can also be performed by adjusting other parameters of the second phase magnetic device, so as to reach the object of reducing loss of the second phase magnetic device. The second phase magnetic device can refer to any phase magnetic device in the three-phase magnetic integrated assembly, and preferably, the second phase magnetic device is located between the first phase magnetic device and the third phase magnetic device.

Asymmetrical design of the three-phase magnetic integrated device in the application can be applied to an integration of three phase transformers, an integration of three phase inductors, a physical integration of three phase transformers and three phase inductors, and an integration of three phase transformers and leakage inductors of three phase transformers, but the application is not limited thereto.

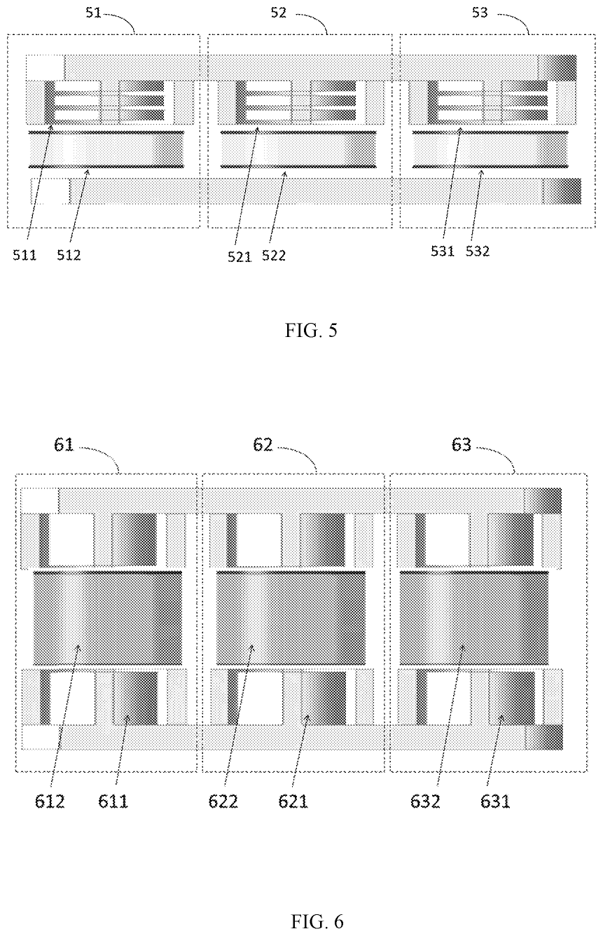

FIG. 5 is a schematic diagram where the three-phase magnetic integrated assembly is an integration of three phase inductors. As shown in FIG. 5, the three-phase magnetic integrated assembly includes a first phase inductor 51, a second phase inductor 52 and a third phase inductor 53, and the second phase inductor 52 is located between the first phase inductor 51 and the third phase inductor 53. A first phase inductor winding 512 is winded onto a first phase inductor magnetic core 511 to form the first phase inductor 51, a second phase inductor winding 522 is winded onto a second phase inductor magnetic core 521 to form the second phase inductor 52, and a third phase inductor winding 532 is winded onto a third phase inductor magnetic core 531 to form the third phase inductor 53.

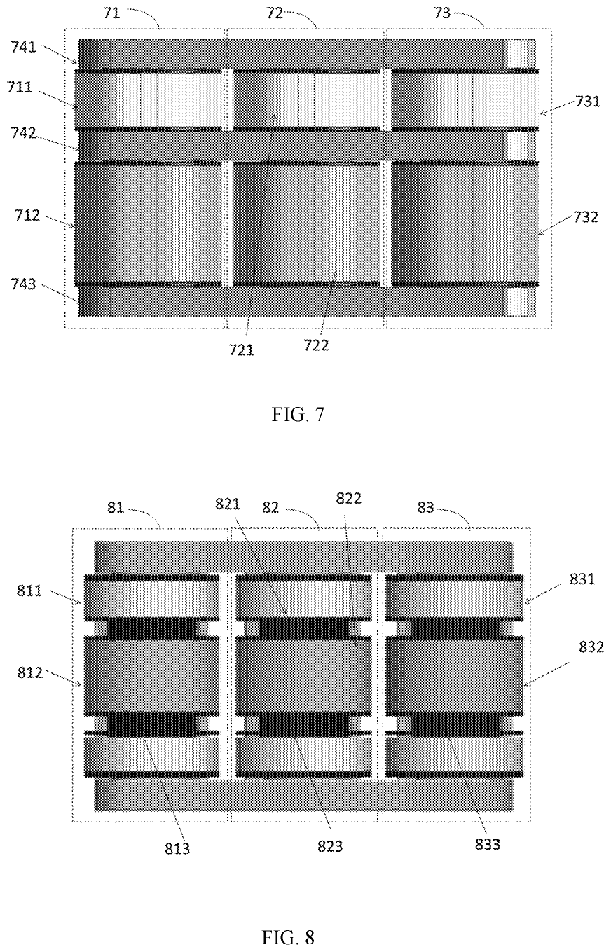

FIG. 6 is a schematic diagram where the three-phase magnetic integrated assembly is an integration of three phase transformers. As shown in FIG. 6, the three-phase magnetic integrated assembly includes a first phase transformer 61, a second phase transformer 62 and a third phase transformer 63, and the second phase transformer 62 is located between the first phase transformer 61 and the third phase transformer 63. A first phase transformer winding 612 is winded onto a first phase transformer magnetic core 611 to form the first phase transformer 61, a second phase transformer winding 622 is winded onto a second phase transformer magnetic core 621 to form the second phase transformer 62, and a third phase transformer winding 632 is winded onto a third phase transformer magnetic core 631 to form the third phase transformer 63.

FIG. 7 is a schematic diagram where the three-phase magnetic integrated assembly is an integration of three phase transformers and three phase inductors. As shown in FIG. 7, the three-phase magnetic integrated assembly includes a first phase magnetic device 71, a second phase magnetic device 72 and a third phase magnetic device 73, and the second phase magnetic device 72 is located between the first phase magnetic device 71 and the third phase magnetic device 73. The first phase magnetic device 71 includes a first phase inductor 711 and a first phase transformer 712, the second phase magnetic device 72 includes a second phase inductor 721 and a second phase transformer 722, and the third phase magnetic device 73 includes a third phase inductor 731 and a third phase transformer 732. The three-phase magnetic integrated assembly further includes a first core plate 741, a second core plate 742 and a third core plate 743 arranged in parallel, wherein the first phase inductor 711, the second phase inductor 721 and the third phase inductor 731 are located between the first core plate 741 and the second core plate 742, and the first phase transformer 712, the second phase transformer 722 and the third phase transformer 732 are located between the second core plate 742 and the third core plate 743. The first phase inductor 711 is formed by winding a first phase inductor winding onto a first phase inductor magnetic core, the second phase inductor 721 is formed by winding a second phase inductor winding onto a second phase inductor magnetic core, and the third phase inductor 731 is formed by winding a third phase inductor winding onto a third phase inductor magnetic core. The first phase transformer 712 is formed by winding a first phase transformer winding onto a first phase transformer magnetic core, the second phase transformer 722 is formed by winding a second phase transformer winding onto a second phase transformer magnetic core, and the third phase transformer 732 is formed by winding a third phase transformer winding onto a third phase transformer magnetic core.

FIG. 8 is a schematic diagram where the three-phase magnetic integrated assembly is an integration of three phase transformers and leakage inductors of the three phase transformers. As shown in FIG. 8, the three-phase magnetic integrated assembly includes a first phase magnetic device 81, a second phase magnetic device 82 and a third phase magnetic device 83, and the second phase magnetic device 82 is located between the first phase magnetic device 81 and the third phase magnetic device 83.

The first phase magnetic device 81 includes a first phase inductor and a first phase transformer, a primary winding 811 and a secondary winding 812 are winded onto a first magnetic core 813 to form the first phase transformer, and the first phase inductor is formed by a leakage inductor of the first phase transformer.

The second phase magnetic device 82 includes a second phase inductor and a second phase transformer, a primary winding 821 and a secondary winding 822 are winded onto a second magnetic core 823 to form the second phase transformer, and the second phase inductor is formed by a leakage inductor of the second phase transformer.

The third phase magnetic device 83 includes a third phase inductor and a third phase transformer, a primary winding 831 and a secondary winding 832 are winded onto a third magnetic core 833 to form the third phase transformer, and the third phase inductor is formed by a leakage inductor of the third phase transformer.

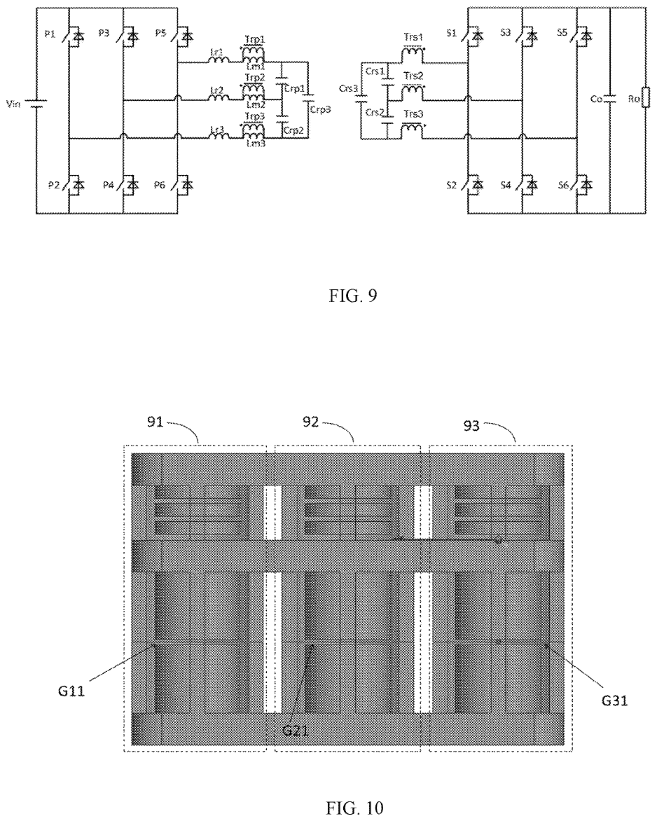

FIG. 9 is a schematic diagram of a circuit topology of the three-phase magnetic integrated assembly. As shown in FIG. 9, the three-phase magnetic integrated circuit includes a first phase inductor and a first phase transformer, a second phase inductor and a second phase transformer, a third phase inductor and a third phase transformer, where Trp1 and Trs1 are a primary side and a secondary side of the first phase transformer, Trp2 and Trs2 are a primary side and a secondary side of the second phase transformer, Trp3 and Trs3 are a primary side and a secondary side of the third phase transformer, and Lr1, Lr2 and Lr3 are a first phase inductor, a second phase inductor and a third phase inductor, respectively.

FIG. 10 is a structural diagram of the symmetrically designed three-phase magnetic integrated assembly. As shown in FIG. 10, the three-phase magnetic integrated assembly includes a first phase magnetic device 91, a second phase magnetic device 92 and a third phase magnetic device 93, the second phase magnetic device 92 is located between the first phase magnetic device 91 and the third phase magnetic device 93, and the first phase magnetic device 91, the second phase magnetic device 92 and the third phase magnetic device 93 include magnetic cores and windings winded onto the magnetic cores, respectively. The magnetic core of the first phase magnetic device 91 has a first air gap G11, the magnetic core of the second phase magnetic device 92 has a second air gap G21, the magnetic core of the third phase magnetic device 93 has a third air gap G31, and a width of the first air gap G11, a width of the second air gap G21 and a width of the third air gap G31 are equal. Hereinafter combining FIGS. 1 and 10, taking the first embodiment for example, adjustment way and achieved technical effects of the second phase magnetic device in the three-phase magnetic integrated assembly are explained.

Table 1 shows inductances of inductors (LrA, LrB, LIB), and inductances of magnetizing inductors (LmA, Lmp, Lmc) of the transformer formed respectively by the first air gap G11, the second air gap G21 and the third air gap G31 of the symmetrically designed three-phase magnetic integrated assembly shown in FIG. 10. Table 2 shows maximum magnetic fluxes of the magnetic device of phases (phase A, phase B, phase C) of the symmetrically designed three-phase magnetic integrated assembly shown in FIG. 10. Table 3 shows core losses of the magnetic device of phases (phase A, phase B, phase C) of the symmetrically designed three-phase magnetic integrated assembly shown in FIG. 10. Combining FIG. 10 and Tables 1-3, in the three-phase magnetic integrated assembly, the width of the first air gap G11, the width of the second air gap G21 and the width of the third air gap G31 are equal, the value of the inductances of magnetizing inductor of the second phase magnetic device 92 and the values of the excitation inductors of other two phase magnetic devices are nearly equal, the maximum magnetic fluxes of the three phase magnetic devices are the same, and loss of the second phase magnetic device 92 and losses of other two phase magnetic devices are also nearly equal.

TABLE 1

| Lr_{A} | Lr_{B} | Lr_{C} | Lm_{A} | Lm_{B} | Lm_{C} |
|---|---|---|---|---|---|
| 8.9443 uH | 8.9539 uH | 8.9458 uH | 49.79 uH | 49.937 uH | 49.782 uH |

TABLE 2

| Phase A | Phase B | Phase C |
|---|---|---|
| 0.166T | 0.166T | 0.166T |

TABLE 3

| Phase A_Center | Phase B_Center | Phase C_Center |
|---|---|---|
| 4.0234 W*1.5 | 4.0350 W*1.5 | 4.0152 W*1.5 |

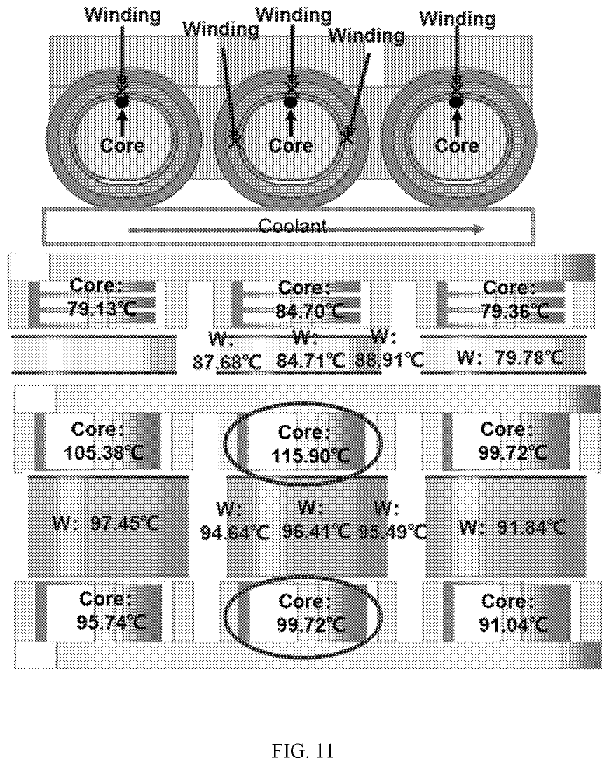

FIG. 11 is a distribution diagram of tested temperatures of the symmetrically designed three-phase magnetic integrated assembly. As shown in FIG. 11, a temperature of an middle phase magnetic device is higher than temperatures of the magnetic devices on both sides.

Table 4 shows of inductors (LrA, LIB, LIB), and inductors (LmA, Lmp, Lmc) of the transformer formed respectively by the first air gap G1, the second air gap G2 and the third air gap G3 of the asymmetrically designed three-phase magnetic integrated assembly in the first preferable embodiment shown in FIG. 1. Table 5 shows maximum magnetic fluxes of the magnetic device of phases (phase A, phase B, phase C) of the asymmetrically designed three-phase magnetic integrated assembly shown in FIG. 1. Table 6 shows core losses of the magnetic device of phases (phase A, phase B, phase C) of the asymmetrically designed three-phase magnetic integrated assembly shown in FIG. 1. Combining FIG. 1 and Tables 4-6, in the three-phase magnetic integrated assembly, a width of the second air gap G2, a width of the first air gap G1 and a width of the third air gap G3 differ by 10% or more, and the width of the second air gap G2 is larger than the width of the first air gap G1 and the width of the third air gap G3. The inductor of the second phase magnetic device is less than the inductors of other two phase magnetic devices, the maximum magnetic flux of the second phase magnetic device is less than the maximum magnetic fluxes of other two phase magnetic devices, and loss of the second phase magnetic device is less than 10% of losses of other two phase magnetic devices.

TABLE 4

| Lr_{A} | Lr_{B} | Lr_{C} | Lm_{A} | Lm_{B} | Lm_{C} |
|---|---|---|---|---|---|
| 8.9438 uH | 8.9551 uH | 8.9452 uH | 49.792 uH | 32.02 uH | 49.784 uH |

TABLE 5

| Phase A | Phase B | Phase C |
|---|---|---|
| 0.172T | 0.138T | 0.175T |

TABLE 6

| Phase A_Center | Phase B_Center | Phase C_Center |
|---|---|---|
| 4.6874 W*1.5 | 2.5021 W*1.5 | 4.8967 W*1.5 |

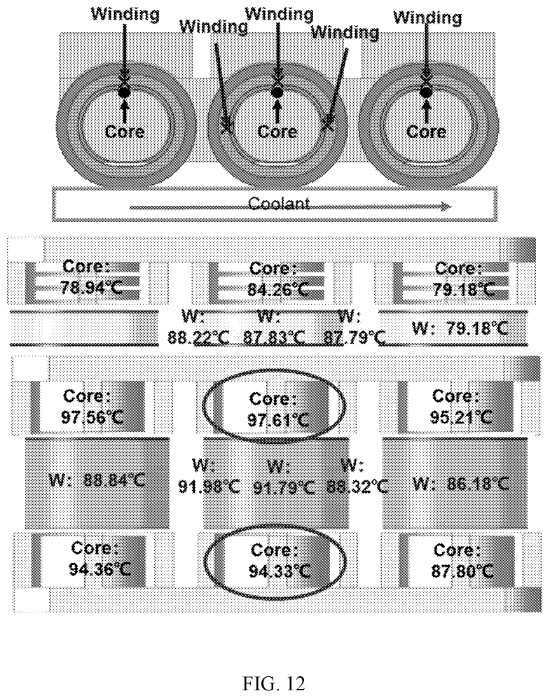

FIG. 12 is a distribution diagram of tested temperatures of the asymmetrically designed three-phase magnetic integrated assembly in the application. As compared to the distribution diagram of tested temperatures of the symmetrically designed three-phase magnetic integrated assembly shown in FIG. 11, a temperature of an middle phase magnetic device in the asymmetrically designed three-phase magnetic integrated assembly is significantly decreased.

Other embodiments in the application can also reach the technical effects of reducing loss of the middle phase magnetic device, and decreasing the temperature of the middle phase magnetic device by adjusting other parameters of the middle phase magnetic device of the three-phase magnetic integrated assembly.

In other embodiments, relevant parameters of the magnetic devices at other positions of the three-phase magnetic integrated assembly can also be adjusted, thereby achieving the technical effects of reducing loss and decreasing the temperature.

The three-phase magnetic integrated assembly provided in the application adjusts parameters of one phase magnetic device through asymmetrical design of the magnetic devices under different heat dissipation conditions, so that loss of the phase magnetic device is less than losses of other phases, and temperatures of the magnetic core and the windings at different positions of the three-phase magnetic integrated assembly are stabilized in a safe temperature range.

Although the embodiments of the application have been illustrated and described, it is appreciated that those ordinary in the art may make various changes, modifications, replacements and variations to these embodiments without departing from principle and spirit of the application, and the protection scope of the application is subjected to the scope defined by the appended claims.

What is claimed is:

1. A three-phase magnetic integrated assembly, comprising
a first phase magnetic device having a first loss,
a second phase magnetic device having a second loss; and
a third phase magnetic device having a third loss,
wherein the second loss is less than 90% of the first loss and 90% of the third loss by adjusting one or more parameters of the second phase magnetic device, and the one or more parameters comprise a thickness of the air gap of a magnetic core, turns of windings, a cross-sectional area of the magnetic core or a length of magnetic core.

2. The three-phase magnetic integrated assembly according to claim 1, wherein the second phase magnetic device is located between the first phase magnetic device and the third phase magnetic device.

3. The three-phase magnetic integrated assembly according to claim 1, wherein,
the thickness of the air gap of the magnetic core of the second phase magnetic device and a thickness of the air gap of a magnetic core of the first phase magnetic device differ by 10% or more,
the thickness of the air gap of the magnetic core of the second phase magnetic device and a thickness of the air gap of a magnetic core of the third phase magnetic device differ by 10% or more.

4. The three-phase magnetic integrated assembly according to claim 3, wherein,
the thickness of the air gap of the magnetic core of the second phase magnetic device is larger than the thickness of the air gap of the magnetic core of the first phase magnetic device,
the thickness of the air gap of the magnetic core of the second phase magnetic device is larger than the thickness of the air gap of the magnetic core of the third phase magnetic device.

5. The three-phase magnetic integrated assembly according to claim 1, wherein,
the turns of windings of the second phase magnetic device and the turns of windings of the first phase magnetic device are different,
the turns of windings of the second phase magnetic device and the turns of windings of the third phase magnetic device are different.

6. The three-phase magnetic integrated assembly according to claim 5, wherein,
the turns of windings of the second phase magnetic device is more than the turns of windings of the first phase magnetic device,
the turns of windings of the second phase magnetic device is more than the turns of windings of the third phase magnetic device.

7. The three-phase magnetic integrated assembly according to claim 1, wherein,
the cross-sectional area of the magnetic core of the second phase magnetic device and a cross-sectional area of a magnetic core of the first phase magnetic device differ by 10% or more,
the cross-sectional area of the magnetic core of the second phase magnetic device and a cross-sectional area of a magnetic core of the third phase magnetic device differ by 10% or more.

8. The three-phase magnetic integrated assembly according to claim 7, wherein,
the cross-sectional area of the magnetic core of the second phase magnetic device is larger than the cross-sectional area of the magnetic core of the first phase magnetic device,
the cross-sectional area of the magnetic core of the second phase magnetic device is larger than the cross-sectional area of the magnetic core of the third phase magnetic device.

9. The three-phase magnetic integrated assembly according to claim 1, wherein,
the length of the magnetic core of the second phase magnetic device and a length of a magnetic core of the first phase magnetic device differ by 10% or more,
the length of the magnetic core of the second phase magnetic device and a length of a magnetic core of the third phase magnetic device differ by 10% or more.

10. The three-phase magnetic integrated assembly according to claim 9, wherein,
the length of the magnetic core of the second phase magnetic device is less than the length of the magnetic core of the first phase magnetic device,
the length of the magnetic core of the second phase magnetic device is less than the length of the magnetic core of the third phase magnetic device.

11. The three-phase magnetic integrated assembly according to claim 1, wherein the three-phase magnetic integrated assembly comprises an inductor.

12. The three-phase magnetic integrated assembly according to claim 1, wherein the three-phase magnetic integrated assembly comprises a transformer.

13. The three-phase magnetic integrated assembly according to claim 1, wherein,
the first phase magnetic device comprises a first inductor and a first transformer,
the second phase magnetic device comprises a second inductor and a second transformer,
the third phase magnetic device comprises a third inductor and a third transformer,
the three-phase magnetic integrated assembly further comprises a first core plate, a second core plate and a third core plate arranged in parallel, wherein the first inductor, the second inductor and the third inductor are located between the first core plate and the second core plate, and the first transformer, the second transformer and the third transformer are located between the second core plate and the third core plate.

14. The three-phase magnetic integrated assembly according to claim 1, wherein,
the first phase magnetic device comprises a first inductor and a first transformer, and a leakage inductor of the first transformer forms the first inductor,
the second phase magnetic device comprises a second inductor and a second transformer, and a leakage inductor of the second transformer forms the second inductor,
the third phase magnetic device comprises a third inductor and a third transformer, and a leakage inductor of the third transformer forms the third inductor.
